(19) United States
(12) Patent Application Publication
(10) Pub. No.: US 2024/0149663 A1
(43) Pub. Date: May 9, 2024

(54) Pressure Vessel System Including a Pressure Vessel Assembly

(71) Applicant: Bayerische Motoren Werke Aktiengesellschaft, Muenchen (DE)

(72) Inventors: Oemer AHMET-TSAOUS, Muenchen (DE); Peter BARTL, Muenchen (DE); Olivier COUSIGNE, Wielenbach (DE); Christopher DETMAR, Muenchen (DE); Timo GUTMANN, Bad Kohlgrub (DE); Eric HENDEL, Frickenhausen (DE); Joerg HENNECKE, Haar (DE); Klaas KUNZE, Poing (DE); Lydia MORAL GRACI, Muenchen (DE); Andreas PELGER, Ismaning (DE); Klaus SZOUCSEK, Zirndorf (DE); Alexander ZOTTER, Muenchen (DE)

(21) Appl. No.: 18/549,087

(22) PCT Filed: Feb. 15, 2022
(86) PCT No.: PCT/EP2022/053657

§ 371 Date: Sep. 5, 2023

(30) Foreign Application Priority Data
Mar. 12, 2021 (DE) 10 2021 106 038.9

(51) Int. Cl. B60K 15/03; B60K 15/063; F17C 13/08

(52) U.S. Cl. CPC B60K 15/03; B60K 15/063; F17C 13/084; B60K 2015/03144; B60K 2015/0321; B60K 2015/0634; F17C 2201/0109; F17C 2201/035; F17C 2201/056; F17C 2205/0111; F17C 2205/0142; F17C 2205/0192; F17C 2205/0326; F17C 2205/0332; F17C 2205/0335; F17C 2205/0341; F17C 2205/0352; F17C 2205/0394; F17C 2221/012; F17C 2221/033; F17C 2250/043; F17C 2250/0439; F17C 2250/0491; F17C 2270/0168

(57) ABSTRACT

The technology disclosed by the invention relates to a pressure vessel system for a motor vehicle for storing fuel, comprising a plurality of pressure vessels (100) that are combined to a pressure vessel assembly (10), the pressure vessels (100), when mounted, being arranged substantially in parallel relative to each other, and the pressure vessels (100) being fluidically interconnected via a common fuel line (200).

### BACKGROUND AND SUMMARY OF THE INVENTION

A pressure vessel system having a pressure vessel assembly for the storage of fuel in a motor vehicle is known from the prior art. It is endeavored to arrange the fuel storage tanks of a motor vehicle in the underfloor region, below the passenger compartment. Available structural space for this purpose requires novel pressure vessel systems, which provide for a plurality of small pressure vessels, rather than a small number of large pressure vessels. The objective is to accommodate the largest quantity of fuel possible in the available structural space, with no significant adverse impact upon costs, weight or other construction parameters. Concepts of this type are known, in principle, from the following published documents: DE 102018215447 B3, DE 102018210699 A1, US 2006102398 AA, DE 102018116090 A1, DE 102018119087 A1, DE 102018000756 A1, DE 102017004902 A1 and EP 3441253 A1.

A preferred object of the technology disclosed herein is the reduction or elimination of at least one disadvantage of a previously known solution, or the proposal of an alternative solution. In particular, a preferred object of the technology disclosed herein is the provision of a cost-effective, lightweight and/or space-appropriate storage concept, which additionally provides a further improvement of safety. Further preferred objects can result from the advantageous effects of the technology disclosed herein.

The technology disclosed herein relates to a pressure vessel system for a motor vehicle (e.g., passenger cars, motorcycles or service vehicles). The pressure vessel system is employed for the storage of fuel which is gaseous under ambient conditions. The pressure vessel system can be employed, for example, in a vehicle which is powered by compressed (also described as “compressed natural gas” or “CNG”) or liquid (also described as “liquid natural gas” or “LNG”) natural gas, or by hydrogen. The pressure vessel system is fluidically connected to at least one energy converter, which is designed to convert the chemical energy of fuel into other forms of energy. The energy converter can be, for example, a combustion engine or a fuel cell system, or a fuel cell stack.

A pressure vessel system of this type comprises a plurality of pressure vessels, preferably composite overwrapped pressure vessels. Pressure vessels can be, for example, high-pressure gas vessels. High-pressure gas vessels are configured, at ambient temperatures, to continuously store fuel at a nominal operating pressure (also described as a “nominal working pressure” or “NWP”) of at least 350 bar overpressure (=overpressure in relation to atmospheric pressure) or at least 700 bar overpressure. A cryogenic pressure vessel is appropriate for the storage of fuel at the above-mentioned working pressures, even at temperatures which lie significantly below (e.g., more than 50 degrees Kelvin or more than 100 degrees Kelvin below) the working temperature of the vehicle.

The motor vehicle can comprise a plurality of pressure vessels. A pressure vessel assembly (also described as a “container assembly”) can preferably comprise pressure vessels and supporting, fastening and/or protective elements which are permanently connected to pressure vessels (e.g., protective shields, screens, barrier layers, covers, coatings, overwrappings, etc.). Appropriately, supporting, fastening and/or protective elements are only temporary, and preferably can only be removed by specialized personnel and/or are not removable in a non-destructive manner. A pressure vessel assembly of this type is particularly appropriate for shallow installation spaces, particularly in the underfloor region below the vehicle passenger compartment. A pressure vessel assembly preferably comprises more than three, or more than five, or more than seven, or more than ten pressure vessels. In the installation site in the motor vehicle, pressures vessels can be oriented in the transverse direction of the vehicle or in the longitudinal direction of the vehicle.

Pressure vessels can assume circular or oval cross-sections. Individual pressure vessels can be configured as storage tubes. For example, a plurality of pressure vessels can be provided, the longitudinal axes of which, in the installation site, are mutually oriented in parallel. The individual pressure vessels can respectively assume a length-to-diameter ratio with a value between 5 and 200, preferably between 7 and 100, and particularly preferably between 9 and 50. The length-to-diameter ratio is the quotient of the total length of the individual pressure vessel (e.g., the total length of a storage tube, without fluid connecting elements), as the numerator, to the greatest external diameter of the pressure vessel, as the denominator. Individual pressure vessels can be arranged in direct proximity to one another, for example with a mutual spacing of less than 20 cm, or less than 15 cm, or less than 10 cm, or less than 5 cm.

The plurality of pressure vessels are fluidically connected to one another by means of a common fuel line. This fuel line is generally arranged up-circuit of a (high-pressure) pressure reducer. The fuel line is appropriately configured to withstand essentially the same pressures as the pressure vessels which are connected to the fuel rail. The individual pressure vessels of the pressure vessel assembly are mutually fluidically connected by means of the fuel line or fuel rail, in a direct manner, such that the individual pressure vessels, under regulation conditions, essentially assume the same pressure, in accordance with the principle of communicating pipes.

The fuel line can preferably be configured in the form of a fuel rail. The fuel rail can also be described as a high-pressure fuel rail. In principle, a fuel rail of this type can be configured in a similar manner to a high-pressure fuel rail of a combustion engine. The fuel rail is preferably formed of a single pipe, of a single block, or of a single housing. The fuel rail appropriately comprises a plurality of rail terminals for the direct connection of pressure vessels. Advantageously, the individual rail terminals are arranged directly on the rail housing, block or pipe, and/or are all arranged with the same mutual spacing. A fuel rail of this type is disclosed, for example, in the German patent applications with the application numbers DE 10 2020 128 607.4 and DE 10 2020 123 037.0, the content of which with respect to the configuration of the fuel rail (also described as a distributor pipe or rail) and the connection of pressure vessels is included herein by way of reference. The fuel rail can essentially be configured as rigid. In this context, the term “rigid” signifies that the fuel rail is resistant to bending, or that, in the regulation operation of the fuel rail, only a degree of bending which is insignificant and immaterial to the operation thereof occurs. In an alternative configuration, the fuel rail can be configured such that the fuel rail can offset positional variations of the pressure vessels, and particularly of the connecting elements thereof. Positional variations are deviations between an actual position of pressure vessels (in operation, during manufacture, during a servicing operation, or in another situation) and a target position assumed in construction. Positional variations result, for example, from the expansion of components (e.g., of pressure vessels) associated with variations in internal pressure and/or variations in temperature. Moreover, positional variations (positional deviations) can occur on the grounds of manufacturing tolerances. The fuel rail can be designed to permit a tolerance equalization perpendicularly to the longitudinal pressure vessel axis of the pressure vessel system. Advantageously, the fuel line or fuel rail and, in general, also the shut-off valve described hereinafter, are constituent elements of the pressure vessel assembly. The connection of pressure vessels to the fuel line or to the proximal ends of pressure vessels can be configured, for example, in the manner disclosed in one of the following published documents: DE 102018118397 A1, EP 3346178 A1, EP 3346179 A1, DE 102018101300 A1, JP 2020128784 A2, JP 2019032034 A2, the content of which with respect to the configuration of the proximal ends and, optionally, of the fuel line is included herein by way of reference.

On, or in direct proximity to each end of the fuel line, at least one thermally activatable pressure relief device can be provided in each case. Proximity to the end comprises the arrangement of TPRDs with a maximum spacing of 0.1×L, where L is the total length of the fuel rail. A thermally activatable pressure relief device, also described as a thermal pressure relief device (=TPRD) or thermal fuse, is generally arranged in proximity to the pressure vessel. In response to the action of heat (e.g., generated by flames), by means of the TPRD, fuel stored in the pressure vessel is released into the environment. The pressure relief device releases fuel, immediately the trip temperature of TPRDs is exceeded (i.e., thermal activation is executed). Trip lines can additionally be provided. A thermal pressure relief system of this type is described, for example, in the German patent application with the publication number DE 102015222252 A1. Advantageously, the prompt detection of a local fire is permitted accordingly.

Appropriately, at the distal ends of pressure vessels with respect to the fuel line, thermally activatable pressure relief devices are provided. Thermally activatable pressure relief devices can advantageously be provided only at the distal ends of the outermost pressure vessels. Advantageously, local heat sources can thus be easily detected, without the necessity for the provision of a thermally activatable pressure relief device at each pressure vessel end, such that complexity of manufacture, manufacturing costs and the number of sealing points are reduced.

In a preferred configuration, pressure relief devices are arranged in separate housings which, in addition to the pressure relief devices, contain further functional components such as sensors and/or valves. For example, the pressure relief device can be arranged in the housing of the shut-off valve which is disclosed herein. At least one pressure relief device can comprise a housing, in or upon which, additionally, a temperature sensor can be provided, particularly at the distal end thereof. Assembly can thus be simplified, and the number of interfaces to be sealed can be reduced.

On the pressure vessel assembly or on the fuel line, an electrically actuatable shut-off valve, which is closed in the de-energized state, can be provided, which is designed to isolate the pressure vessel assembly or the fuel rail vis-à-vis other fuel-bearing lines of the fuel supply installation which serves the energy converter. This shut-off valve assumes the function of an on-tank valve in a conventional pressure vessel. Appropriately, only one shut-off valve which is closed in the de-energized state is provided. The shut-off valve, for example, can be screwed directly onto or into the pressure vessel assembly. The (common) shut-off valve is the first valve which is arranged down-circuit of any of the pressure vessels which is connected to the common fuel line. A pipe rupture protection device, also described as an excess flow valve, can be provided on each pressure vessel, on the fuel line or in the shut-off valve housing. Appropriately, on one connection side of the shut-off valve, pressure vessels of the pressure vessel assembly are provided by way of communicating pipes, with no further electrically actuatable shut-off valve and, on the other connection side, the remainder of the fuel supply installation, including the energy converter, is provided (in general, the remaining components of the anode subsystem of a fuel cell system). Preferably, an excess flow valve and/or the thermally actuatable pressure relief device is/are additionally provided in the tank shut-off valve housing.

The pressure vessel system can further comprise at least one further pressure vessel for the storage of fuel. The at least one further pressure vessel can assume a fuel storage volume which is greater than the fuel storage volume of the largest pressure vessel in the pressure vessel assembly by at least a factor of two, or by at least a factor of three, or by at least a factor of five. If all the pressure vessels in the assembly have the same fuel storage volume, this will be the fuel storage volume considered. Preferably, the at least one further pressure vessel is arranged below or to the rear of a seat, particularly of the rear seats. A particularly large quantity of fuel can be stored in the vehicle accordingly.

In a preferred configuration, the volume ratio assumes a value between 0.15 and 1.0, or a value between 0.2 and 0.75, or a value between 0.25 and 0.5. The volume ratio is the quotient of the fuel volume of the at least one further pressure vessel, as the numerator, to the total fuel volume of all the pressure vessels in the pressure vessel assembly, as the denominator. Simulations and trials have shown that, within this range of volume ratios, negligibly small excess flow processes occur between the pressure vessel assembly and the further pressure vessel upon tapping and, at the same time, a large quantity of fuel can be stored in the vehicle.

The pressure vessel system can further comprise at least one underfloor chassis, which can be fitted to a vehicle body from below. The pressure vessel assembly and the underfloor chassis can be configured such that the pressure vessel assembly can be inserted or fitted into the underfloor chassis from above, wherein the unit formed by the underfloor chassis and the pressure vessel assembly can be fitted to the vehicle body from below. This facilitates the installation and removal of the pressure vessel system. Moreover, the pressure vessel system is thus effectively protected against climatic influences and other environmental influences.

Appropriately, the proximal ends of pressure vessels, with respect to the fuel line, are configured in the form of fixed bearings. Further advantageously, the distal ends of pressure vessels, with respect to the fuel line, are configured in the form of floating bearings. Advantageously, the ends of pressure vessels are mutually connected by means of common retaining elements (e.g., cross members). According to one configuration, these common retaining elements, at the distal end, can be provided such that the retaining element as a whole moves in relation to the fixed bearing, in order to compensate any longitudinal expansion. In another configuration, the floating bearing is configured such that i) each pressure vessel, or ii) only a number of pressure vessels, by way of a subgroup, are configured in a displaceable manner, in combination, relative to the fixed bearing. For example, the fixed bearing—floating bearing principle can be implemented as per published document US 2019047409 AA, or as per the German patent application with the application number DE 10 2021 102 694.6, the content of which with respect to the configuration of floating bearings is included herein by way of reference.

Advantageously, fuel line-related variations in length can thus be offset in a simple manner.

Advantageously, pressure vessels, in the installed position, are essentially arranged between the door sills. Alternatively or additionally, the underfloor chassis can comprise side-mounted energy-absorbing crash deformation structures, preferably by way of truss structures, which are designed to at least reduce the impact energy which is transmitted to the pressure vessel in the event of a collision.

In a preferred configuration, the bottom panel of the underfloor chassis comprises supporting members, as disclosed, for example, in EP 3667151 A1 or in the German patent applications with the application numbers DE 10 2020 128 607.4 and DE 10 2020 123 037.0, the content of which with respect to the configuration of supporting members (described therein either as “supporting members” or as “fixing elements”) and with respect to the connection of pressure vessels is included herein by way of reference.

The electrical energy storage apparatus is an apparatus for storing electrical energy, particularly for the propulsion of at least one electric (traction) drive machine. The energy storage apparatus comprises at least one individual cell, which forms the electrochemical storage cell. In general, a plurality of individual cells are provided. For example, the energy storage apparatus can be a high-voltage accumulator or a high-voltage battery.

The underfloor chassis can be configured to accommodate the pressure vessel assembly, the at least one electrical energy storage apparatus and the at least one further pressure vessel, such that the pressure vessel assembly, the electrical energy storage apparatus and the pressure vessel can be fitted to the motor vehicle in combination with the underfloor chassis.

In other words, the technology disclosed herein relates to a tank system (=pressure vessel system) having, for example, six flat storage tanks (=pressure vessels) and a rear seat tank (=further tank). The distributor unit valve (=shut-off valve, including its housing; c.f. FIG. 2) is connected to the rail (=fuel rail), and comprises a manually closable valve, a TPRD, a check valve opening into the rail with an up-circuit filter, and an excess flow valve and a bleed valve arranged fluidically in parallel with the check valve. At the other end of the rail, a distributor unit fire protection device is connected to the rail, and incorporates a TPRD by way of a subcomponent (c.f. FIG. 3).

In the outermost flat storage tanks, in each case, a tank end plug is screwed into the distal end of the flat storage tank. This can comprise the following, by way of subcomponents: a TPRD, including a blow-off line, and a temperature sensor.

Advantageously, a TPRD is thus provided at all four corners of the flat storage module (=pressure vessel assembly). Any point source of heat can thus be detected with greater rapidity. Each TPRD which is activated is appropriately capable of permitting the escape of the entire fuel content of the flat storage module into the environment. In trials and simulations, it has been established that temperature movements within the pressure vessel assembly disclosed herein are comparatively similar during fueling and tap-off operations, such that one or two temperature sensors are sufficient to permit the detection of temperature within the pressure vessel assembly.

In a further configuration, it can be provided that the pressure vessel assembly comprises only one temperature sensor. The single temperature sensor can preferably be arranged in, or on, or in proximity to the shut-off valve housing. In an alternative configuration, it can be provided that the sensor is arranged on, or in proximity to the opposing end of the fuel line from the shut-off valve end. This provides an advantage, in that manufacturing costs are reduced. Moreover, interfaces for TPRDs which are arranged at the distal ends of pressure vessels can thus be configured with smaller dimensions, as these interfaces only comprise TPRDs, with no additional temperature sensor. Overall, this impacts advantageously upon the utilization of structural space. Additionally, it is not necessary for electrical conductors to be routed to the distal ends of pressure vessels. The temperature sensor is appropriately integrated, such that the temperature sensor is set up for the detection of temperature both during fueling and during tapping. If only one pressure vessel assembly is provided, with no further pressure vessel (e.g., a rear seat tank), the pressure sensor might also be transferred from the pressure reducing unit to the shut-off valve housing. The pressure sensor is advantageously provided, such that is it arranged between the fuel line and the shut-off valve. A pressure measurement can thus be executed, even when the shut-off valve is closed.

In particular, any missing information with respect to the temperature in the tank can be replaced as follows:
in the fueling mode of operation, the tank temperature in pressure vessels can be calculated using a mathematical model. Input variables are the measured pressure and the measured temperature in the fuel line up-circuit of the shut-off valve. Upon the completion of fueling, pressure vessels experience cooling, and the pressure drops. By reference to the pressure drop, in a preferred configuration, a plausibility check of the temperature determined can be executed;
in the driving mode of operation (or tapping), for H₂ mass flow rates with effect from e.g., 1 kg/h, the tank temperature can be measured by means of the temperature sensor on the shut-off valve; and
in the parking mode of operation (or storage), any measurement of the tank temperature can preferably be omitted.

Additionally to the above-mentioned improvement measures, according to one variant, a pressure vessel expansion signal might be made available. This signal might originate from the measurement of a variation in length, diameter, circumference or volume, and be transmitted as an input signal to the tank controller. Pressure in a pressure vessel can be determined accordingly.

In a further configuration, the single temperature sensor is arranged at a distal end of one of the pressure vessels in the pressure vessel assembly.

Appropriately, only a single temperature sensor can thus be provided on or in the pressure vessel assembly wherein, preferably, the single temperature sensor: i) is arranged on, or in proximity to one of the ends of the fuel line, or ii) is arranged at the distal end of a pressure vessel.

The technology disclosed herein will now be described with reference to the figures.

### BRIEF DESCRIPTION OF THE DRAWINGS

FIG. 1 shows a schematic view of a pressure vessel system;

FIG. 2 shows a schematic view of the shut-off valve 212 according to FIG. 1;

FIG. 3 shows a schematic view of TPRDs 220 according to FIG. 1;

FIG. 4 shows a schematic view of TPRDs 120 according to FIG. 1;

FIG. 5 shows a perspective view of the pressure vessel assembly 10 according to FIG. 1;

FIG. 6 shows a schematic view of the underfloor chassis 20 according to FIG. 1; and

FIG. 7 shows a schematic view of the mounting principle of the pressure vessel assembly 10 according to FIG. 1.

### DETAILED DESCRIPTION OF THE DRAWINGS

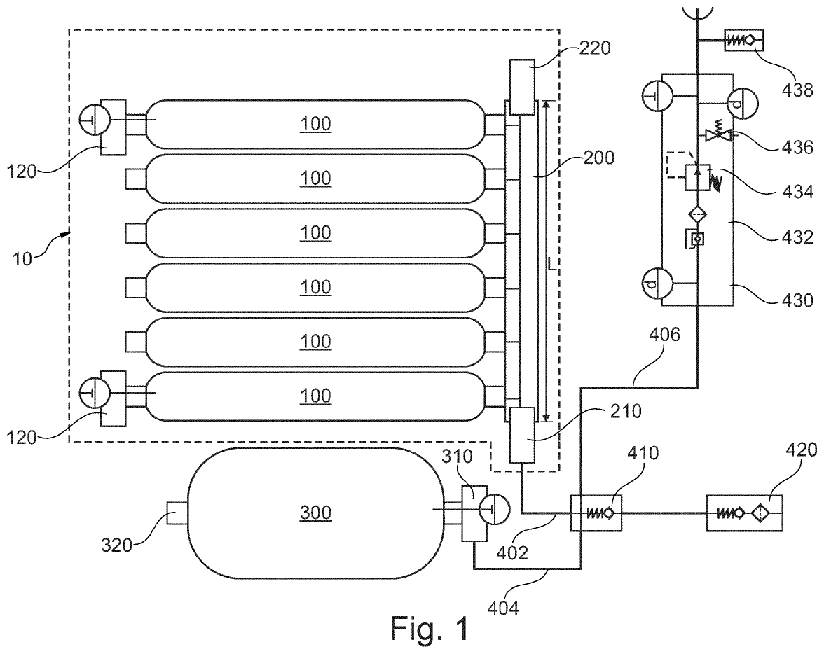

FIG. 1 shows a schematic view of the pressure vessel system according to the technology disclosed herein. The tank nozzle 420 is fluidically connected by means of a fuel line to a distributor unit 410. In the distributor unit 410, a check valve can be provided, which is designed to prevent any backflow to the tank nozzle 420. The distributor unit 410 is fluidically connected to an on-tank valve 310 of the further pressure vessel 300 which, for example, can be arranged below the rear seats. In the on-tank valve 310, appropriately, a shut-off valve, a temperature sensor, a pipe rupture protection device and/or a filter can be provided (in part, not represented here). In a further configuration, a TPRD can also be provided at the opposing end of the further pressure vessel 300.

A fuel line 406 connects the distributor unit 410 to a pressure reducing unit 430 in which, in this case, a pipe rupture protection device 432, at least one pressure sensor, at least one temperature sensor, a mechanical safety valve 436 and a pressure reducer 434 can be provided. Down-circuit of the pressure reducer 434, moreover, a service interface 438 is provided in this case, which is configured for the release of fuel.

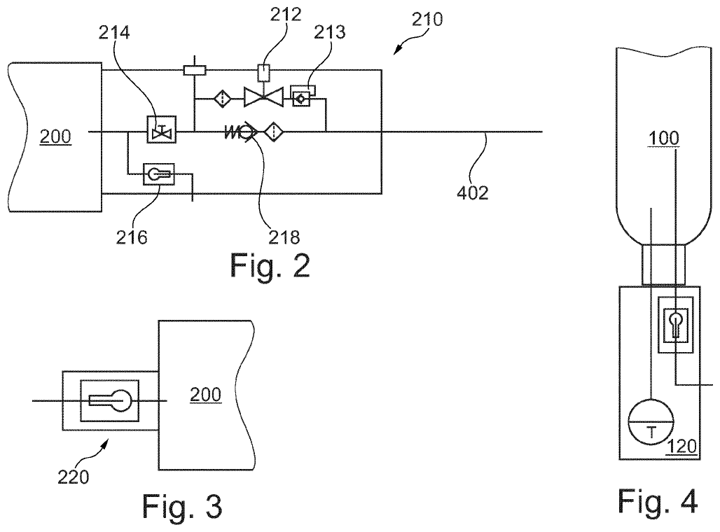

The fuel line 402 connects the distributor unit 410 to the shut-off valve 212. The shut-off valve 212 (c.f. FIG. 2) is an electrically actuatable shut-off valve, which is designed to isolate the fluidic connection of the pressure vessel assembly 10 from the remainder of the fuel supply system. Here, the fuel line 200 is configured in the form of a fuel rail. It is arranged in, or on the pressure vessel assembly 10. The fuel rail is a line, from which rail terminals for the attachment of individual pressure vessels 100 originate. The fuel line 200 can be configured as a mechanically rigid fuel rail such that, even in the event of an intrusion associated with an accident, the fuel rail does not fail. Alternatively, a comparatively flexible fuel line can be provided, which is accommodated in a line housing. The function of the line housing is to additionally protect the fuel line 200 against mechanical intrusion. The individual pressure vessels 100 of the pressure vessel assembly 10 are essentially arranged in parallel with one another, and arranged with a equal spacing from one another. In this case, these pressure vessels 100 assume essentially the same length. Depending upon the structural space in which the pressure vessel assembly 10 is to be installed, individual pressure vessels 100 of the pressure vessel assembly 10 can assume a different length and/or a different diameter. Preferably, between the individual pressure vessels 100 and the fuel line 200, no further electrically actuatable shut-off valves are provided such that, in the regulation operation of the pressure vessel system, the individual pressure vessels 100 of the pressure vessel assembly 10 are directly fluidically connected to one another, in the manner of communicating pipes. In this case, the reference symbol L represents the overall length of the fuel line 200.

The ends of the pressures vessels 100 which are connected to the fuel line 200 are the proximal ends of the pressure vessels 100. The ends of the pressure vessels 100 which are arranged on the opposing side, with respect to the fuel line 200, are the distal ends of the pressure vessels 100.

Advantageously, at the distal ends of the two outermost pressure vessels 100—i.e., those pressure vessels 100 which, in an overhead view, do not have a further pressure vessel 100 arranged on either side—one TPRD and, advantageously, also one temperature sensor are provided in each case. In the housing or unit of the shut-off valve 212, a TPRD is also provided. Moreover, on, or in proximity to the end of the fuel line, a TPRD is provided, which is arranged in opposition to the shut-off valve 212. Advantageously, the TPRDs, sensors and valves, subject to the arrangement thereof at the same locations on the pressure vessels 100 or on the fuel rail 200, are accommodated in common housings or units such that, advantageously, the number of interfaces to be sealed is reduced.

In a further configuration, it can be provided that the pressure vessel assembly 10 comprises only one temperature sensor. The single temperature sensor can preferably be arranged in, or on, or in proximity to the housing of the shut-off valve 212. In an alternative configuration, it can be provided that the sensor is arranged on, or in proximity to the opposing end of the fuel line from the shut-off valve 212 end. This provides an advantage, in that manufacturing costs are reduced. Moreover, interfaces for TPRDs which are arranged at the distal ends of pressure vessels can thus be configured with smaller dimensions, as these interfaces only comprise TPRDs, with no additional temperature sensor. Overall, this impacts advantageously upon the utilization of structural space. Additionally, it is not necessary for electrical conductors to be routed to the distal ends of pressure vessels. The temperature sensor is appropriately integrated, such that the temperature sensor is set up for the detection of temperature both during fueling and during tapping. If only one pressure vessel assembly is provided, with no further pressure vessel (e.g., a rear seat tank), the pressure sensor might also be transferred from the pressure reducing unit to the shut-off valve housing. The pressure sensor is advantageously provided, such that is it arranged between the fuel line 200 and the shut-off valve 212. A pressure measurement can thus be executed, even when the shut-off valve 212 is closed.

In particular, any missing information with respect to the temperature in the tank can be replaced as follows:
in the fueling mode of operation, the tank temperature in pressure vessels can be calculated using a mathematical model. Input variables are the measured pressure and the measured temperature in the fuel line 200 up-circuit of the shut-off valve 212. Upon the completion of fueling, pressure vessels experience cooling, and the pressure drops. By reference to the pressure drop, in a preferred configuration, a plausibility check of the temperature determined can be executed;
in the driving mode of operation (or tapping), for H₂ mass flow rates with effect from e.g., 1 kg/h, the tank temperature can be measured by means of the temperature sensor on the shut-off valve; and
in the parking mode of operation (or storage), any measurement of the tank temperature can preferably be omitted.

Additionally to the above-mentioned improvement measures, according to one variant, a pressure vessel expansion signal might be made available. This signal might originate from the measurement of a variation in length, diameter, circumference or volume, and be transmitted as an input signal to the tank controller. Pressure in a pressure vessel can be determined accordingly.

In a further configuration, the single temperature sensor is arranged at a distal end of one of the pressure vessels in the pressure vessel assembly.

FIG. 2 shows the shut-off valve 212, which is designed to isolate the pressure vessel assembly 10 from the remainder of the fuel supply system. In the housing 210 of the shut-off valve 212, a pipe rupture protection device 213, a manual valve 214 and/or a TPRD 216 are further provided. In a flow path which is arranged in parallel with the pipe rupture protection device 213, a check valve 218 is provided, which interrupts the flux in an outward direction of flow from the pressure vessel, and which releases the flux in a direction of flow towards the pressure vessels. Up-circuit of these two flow paths, the manual valve 214 and the TPRD can be arranged. In general, the housing is configured in the form of a valve unit, in which the corresponding flow channels and subcomponents are incorporated. Advantageously, the number of interfaces which require sealing against leaks can thus be reduced.

FIG. 3 shows the other end of the fuel line 200. At this end, a TPRD 220 is arranged. FIG. 4 shows a structural unit, which is arranged at a distal end of a pressure vessel 100. This structural unit can also be described as a block or housing. In this case, the TPRD 120 and a temperature sensor are integrated in this housing.

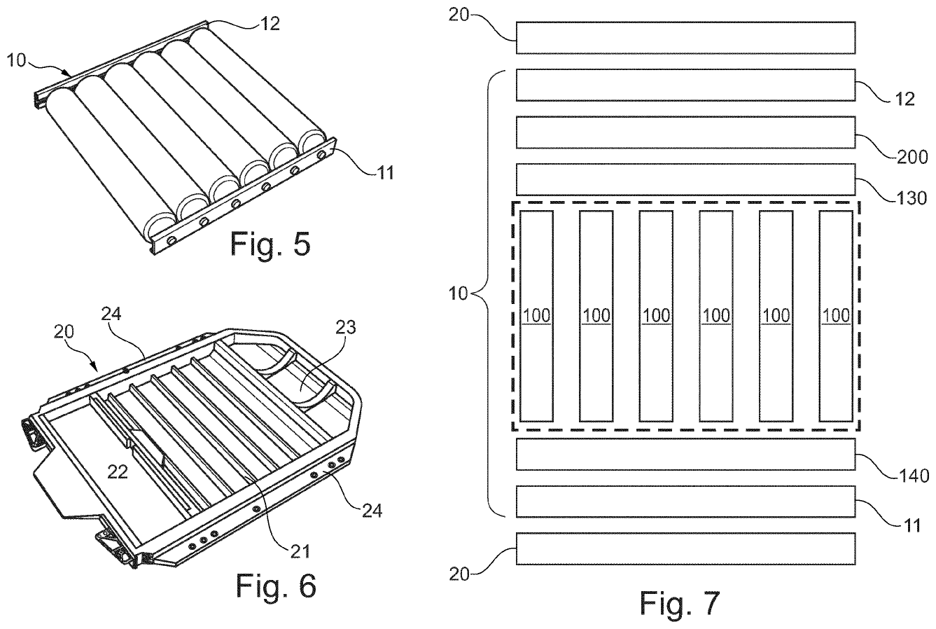

FIG. 5 shows a pressure vessel assembly 10. It comprises a plurality of pressure vessels 100 (in this case, six pressure vessels), which are mechanically coupled to one another, and which thus form a mechanical unit—the pressure vessel assembly 10. The individual pressure vessels are mutually coupled at their respective ends. A rail is employed for this purpose which, in this case, secures the individual pressure vessels 100, and which additionally stiffens the assembly. In place of a rail, on one side, a correspondingly rigid fuel rail might also be provided. Advantageously, in one configuration, an (unrepresented) fuel line 200 can be provided on one side, which can additionally be protected against mechanical loads by a stable line housing.

FIG. 6 shows an underfloor chassis 20. It is subdivided into an energy store locator region 22, in which the energy store of the motor vehicle can be accommodated, an assembly locator region 21 for the pressure vessel assembly 10, and a further locator region 23 for the further pressure vessel 300. The underfloor chassis 20 appropriately comprises lateral attachment regions 24, which are employed for the attachment of the underfloor chassis 20 to the vehicle bodywork.

FIG. 7 shows a schematic view of the mounting assembly of the pressure vessel assembly 10 according to FIG. 1. In this case, the pressure vessels 100 are arranged in parallel with one another. At the proximal ends of the pressure vessels 100, the fixed bearing 130 is arranged. The fuel line 200 is also arranged on this side. On the opposing side of the pressure vessels 100, the floating bearing 140 is arranged. In this case, the pressure vessels 100, the bearings 130, 140 and the fuel line are accommodated in the underfloor chassis 20. In turn, the underfloor chassis 20 is secured to the vehicle bodywork at the vehicle bodywork connection regions 30. Further components of the pressure vessel assembly 10, including, for example, any valves, TPRDs, etc., are not represented.

In the interests of clarity, and by way of simplification, the expression “at least one” has been partially omitted. Where a feature of the technology disclosed herein is described in the singular, or by the indefinite article (e.g., the/a pressure vessel, the/a energy storage apparatus, etc.), a plurality thereof are also disclosed at the same time (e.g., the at least one energy storage apparatus, etc.).

The term “essentially” (e.g., “pressure vessels essentially arranged in parallel”), in the context of the technology disclosed herein, comprises both the exact property or exact value concerned (e.g., “pressure vessels arranged in parallel”) and any deviations which, in each case, are immaterial to the function of the property/value (e.g., “a tolerable deviation from pressure vessels arranged in parallel”).

The preceding description of the present invention is provided by way of illustration only, and is not intended to limit the invention. In the context of the invention, a variety of alterations and modifications are possible, without departing from the scope of the invention, or any equivalents thereof.

1.-15. (canceled)

16. A pressure vessel system for storage of fuel in a motor vehicle, comprising:
a plurality of pressure vessels which are combined in a pressure vessel assembly, wherein the plurality of pressure vessels, in an installed position, are essentially arranged in parallel with one another and wherein the plurality of pressure vessels are mutually fluidically connected by a common fuel line.

17. The pressure vessel system according to claim 16, wherein the fuel line is configured in a form of a fuel rail.

18. The pressure vessel system according to claim 16, further comprising at least one respective thermally activatable pressure relief device disposed on, or in direct proximity to, each end of the fuel line.

19. The pressure vessel system according to claim 16, further comprising a respective thermally activatable pressure relief device disposed at a distal end of the plurality of pressure vessels with respect to the fuel line.

20. The pressure vessel system according to claim 16, further comprising a respective thermally activatable pressure relief device disposed only at a distal end of outermost pressure vessels of the plurality of pressure vessels.

21. The pressure vessel system according to claim 19, wherein the respective thermally activatable pressure relief device comprises a housing, in or on which, additionally, a temperature sensor is disposed

22. The pressure vessel system according to claim 16, wherein only a single temperature sensor is provided on or in the pressure vessel assembly.

23. The pressure vessel system according to claim 22, wherein the single temperature sensor: i) is arranged on, or in proximity to, an end of the fuel line, or ii) is arranged at a distal end of a pressure vessel of the plurality of pressure vessels.

24. The pressure vessel system according to claim 16, further comprising at least one further pressure vessel for storage of fuel, wherein the at least one further pressure vessel assumes a first fuel storage volume which is greater than a second fuel storage volume of a largest pressure vessel in the pressure vessel assembly by at least a factor of two.

25. The pressure vessel system according to claim 16, wherein a volume ratio assumes a value between 0.15 and 1.0 and wherein the volume ratio is a quotient of the first fuel storage volume of the at least one further pressure vessel, as a numerator, to a total fuel storage volume of all of the plurality of pressure vessels in the pressure vessel assembly, as a denominator.

26. The pressure vessel system according to claim 16, further comprising an underfloor chassis which is fittable to a vehicle body from below, wherein the pressure vessel assembly and the underfloor chassis are configured such that the pressure vessel assembly is fittable into the underfloor chassis from above and wherein a unit formed by the underfloor chassis and the pressure vessel assembly is fittable to the vehicle body from below.

27. The pressure vessel system according to claim 17, wherein proximal ends of the plurality of pressure vessels are configured in a form of fixed bearings, wherein distal ends of the plurality of pressure vessels are configured in a form of floating bearings, and wherein the fuel rail is arranged at the proximal ends.

28. The pressure vessel system according to claim 16, further comprising a shut-off valve disposed on the fuel line, wherein the plurality of pressure vessels of the pressure vessel assembly are configured in a form of communicating pipes with no further electrically actuatable shut-off valve.

29. The pressure vessel system according to claim 28, wherein, in a housing of the shut-off valve, a pipe rupture protection device is provided and/or a thermally activatable pressure relief device is provided.

30. The pressure vessel system according to claim 26, wherein the underfloor chassis is configured to accommodate the pressure vessel assembly, an electrical energy storage apparatus, and at least one further pressure vessel such that the pressure vessel assembly, the electrical energy storage apparatus, and the at least one further pressure vessel is fittable to the motor vehicle in combination with the underfloor chassis.
